(19) United States
(12) Patent Application Publication
(10) Pub. No.: US 2008/0273646 A1
(43) Pub. Date: Nov. 6, 2008

(54) SAMPLING CLOCK OFFSET TRACKING AND SYMBOL RE-TIMING

(75) Inventors: Nejib Ammar, Mountain View, CA (US); Yu-Wen Evan Chang, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MEDIAPHY CORPORATION, SAN JOSE, CA (US)

(21) Appl. No.: 12/113,778

(22) Filed: May 1, 2008

Related U.S. Application Data
(60) Provisional application No. 60/915,613, filed on May 2, 2007.

(51) Int. Cl. H04L 7/00

(52) U.S. Cl. 375/371; 375/260

(57) ABSTRACT

Systems, devices, and methods are described for sampling clock offset tracking and timing correction. Wireless signals are received, some of which include a control signal known at the receiver. A first received signal may be correlated with the control signal to produce a reference correlation. A second, later received signal may be correlated with the control signal to produce a second correlation. A difference measurement between the reference correlation and the second correlation may be calculated to estimate drift. The estimated drift may be corrected.

### CROSS REFERENCES

This application claims priority from co-pending U.S. Provisional Patent Application No. 60/915,613, filed May 2, 2007, entitled “SAMPLING CLOCK OFFSET TRACKING AND SYMBOL RE-TIMING” (Attorney Docket No. 025950-000400US), which is hereby incorporated by reference, as if set forth in full in this document, for all purposes.

### BACKGROUND

The present invention relates to wireless communications in general and, in particular, to sampling clock tracking and re-timing.

Orthogonal Frequency Division Multiplexing (OFDM) is a widely adopted signaling scheme for wireless communications, due at least in part to its robustness against the effects of multipath fading channel propagation. OFDM has high spectral efficiency, carrying the modulated bit-streams on individual orthogonal subcarriers. This transmission technique is especially suited for mitigating the effect of the multipath fading channel that often occurs during mobile reception. However, a drawback of OFDM transport systems is their high sensitivity to synchronization inaccuracies.

Synchronization errors may occur because of carrier frequency offset and sampling clock mismatches. For example, oscillator variations because of tuning oscillator instabilities or other errors can occur at both the transmitter and receiver. Synchronization errors may also be caused by Doppler shifts induced by the channel.

These synchronization issues may result in OFDM inter-carrier interference (ICI) and/or inter symbol interference (ISI), thereby deteriorating the system performance. It is also worth noting that symbol timing and timing recovery may grow in importance as the number of OFDM subcarriers (and, thus, the number of samples) increases. This may be the case in certain implementations of the Digital Video Broadcasting (DVB), ISDB, and DMB video broadcasting standards. Offsets between transmit and receive oscillator frequencies may cause a sampling delay that drifts linearly in time over the OFDM symbol. Consider an example in which the oscillators have a 20 parts per million (ppm) precision, i.e., an offset between a pair of oscillators can be up to 2×10⁻⁵ of a sample. In a 2K mode DVB system (the FFT size is 2048), the drift may amount to 1 sample error every 24 OFDM symbols. This drift may thus be doubled and quadrupled in the 4K and 8K modes respectively.

In a number of OFDM tracking and compensation algorithms, clock drift may be ignored, and they instead may rely on initial timing delay estimation. While some algorithms address clock drift, some such methods may face performance issues in high Doppler environments. Also, some solutions may have high costs in terms of complexity and power consumption. Therefore, it may be desirable to have novel systems, devices, and methods for tracking and correcting synchronization inaccuracies and which address one or more of the above-described deficiencies.

### SUMMARY

Systems, devices, processors, and methods are described for sampling clock offset tracking and timing correction. Wireless signals are received, some of which include a control signal known at the receiver. A first received signal may be correlated with the control signal to produce a reference correlation. A second, later arriving received signal may be correlated with the control signal to produce a second correlation. A difference measurement between the reference correlation and the second correlation may be calculated to estimate drift. The estimated drift may be corrected.

In one embodiment, the wireless signals are OFDM signals, including scattered pilots, transmitted according to the DVB-H standard. The pilots may be the control signal known at the receiver. In some embodiments, the control signal may be periodic, but in other cases the control signal need not be periodic. The difference measurement may be calculated by cross-correlating the reference correlation and the additional correlation.

Once the estimated drift is calculated, a determination may be made whether the estimated drift exceeds a confidence threshold. If so, the sampling rate may be modified at the receiver to correct the estimated drift. Also, a determination may be made whether the interval between correlations will be modified based on the amount of estimated drift and the variability of previously estimated drift. At the appropriate interval, a later received signal may be correlated with the pilots to produce an additional correlation, and the re-timing loop resumes.

If a determination is made that the estimated drift fails to meet the confidence threshold, a later arriving wireless signal may be correlated with the pilots to produce a second additional correlation. A difference measurement may then be calculated by cross-correlating the reference correlation and the second additional correlation to estimate drift. Note that in still other embodiments, additional correlations may be performed on later arriving signals and compared or integrated in other ways.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a wireless system configured according to various embodiments of the invention.

FIG. 2 is a block diagram of a receiver device including components configured according to various embodiments of the invention.

FIG. 3 is a representation of an index illustrating a range of subcarriers over time for a multicarrier signal according to various embodiments of the invention.

FIG. 4 is a graph illustrating an autocorrelation reference sequence according to various embodiments of the invention.

FIG. 5 is a graph illustrating a reference correlation and monitoring correlation according to various embodiments of the invention.

FIG. 6 is a graph representing a delay profile according to various embodiments of the invention.

FIG. 7 is a block diagram of a symbol sychronization unit configured according to various embodiments of the invention.

FIG. 8 is a flowchart illustrating a method of sampling clock tracking according to various embodiments of the invention

FIG. 9 is a flowchart illustrating a method of sampling clock tracking and timing correction according to various embodiments of the invention.

FIG. 10 is a flowchart illustrating an alternative method of sampling clock tracking and timing correction according to various embodiments of the invention.

### DETAILED DESCRIPTION OF THE INVENTION

Systems, devices, processors, and methods are described for sampling clock offset tracking and timing correction. For example, in one embodiment, a mobile communications device receives wireless signals, some of which include a control signal known at the receiver. The device correlates one of the received signals with the known control signal to produce a reference correlation. The device correlates a second, later arriving one of the received signals with the control signal to produce a second correlation. The device calculates a difference measurement between the reference correlation and the second correlation to estimate drift. The device may correct the estimated drift.

The following description provides example embodiments only, and is not intended to limit the scope, applicability, or configuration of the invention. Rather, the ensuing description of the embodiments will provide those skilled in the art with an enabling description for implementing embodiments of the invention. Various changes may be made in the function and arrangement of elements without departing from the spirit and scope of the invention.

Thus, various embodiments may omit, substitute, or add various procedures or components, as appropriate. For instance, it should be appreciated that in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner.

It should also be appreciated that the following systems, methods, and software may individually or collectively be components of a larger system, wherein other procedures may take precedence over or otherwise modify their application. Also, a number of steps may be required before, after, or concurrently with the following embodiments.

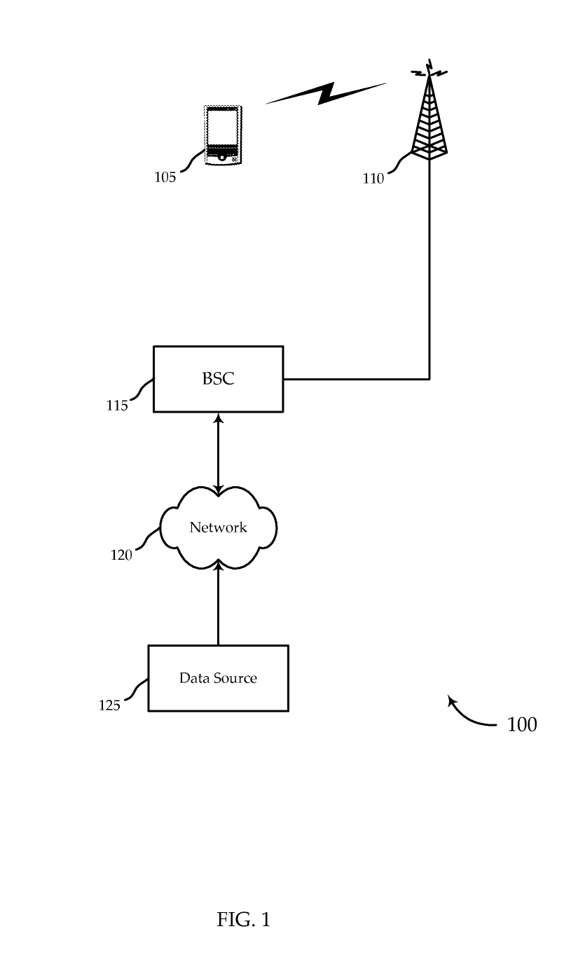

Systems, devices, methods, and software are described for symbol synchronization at a receiver. Turning to FIG. 1, an example communications system 100 for implementing embodiments of the invention is illustrated. The system includes a communications device 105. The communications device 105 may be a cellular telephone, other mobile phone, personal digital assistant (PDA), portable video player, portable multimedia player, portable DVD player, laptop personal computer, a television in transportation means (including cars, buses, and trains), portable game console, digital still camera or video camcorder, or other device configured to receive wireless communications signals.

In the illustrated embodiment, the device 105 communicates with one or more base stations 110, here depicted as a cellular tower. A base station 110 may be one of a collection of base stations utilized as part of a system 100 that communicates with the device using wireless signals. Thus, the communications device 105 may receive wireless signals from the base station 110, and estimate and correct drift over time according to embodiments of the invention. These novel sampling clock offset tracking and timing correction techniques will be described in detail below.

The base station 110 is in communication with a Base Station Controller (BSC) 115 that routes the communication signals between the network and the base station 110. In other embodiments, other types of infrastructure network devices or sets of devices (e.g., servers or other computers) may also serve as an interface between a network 120 and the base station 110. For example, a BSC 115 may communicate with a Mobile Switching Center (MSC) that can be configured to operate as an interface between the device 105 and a Public Switched Telephone Network (PSTN).

The network 120 of the illustrated embodiment may be any type of network, and may include, for example, the Internet, an IP network, an intranet, a wide-area network (WAN), a local-area network (LAN), a virtual private network (VPN), the Public Switched Telephone Network (PSTN), or any other type of network supporting data communication between any devices described herein. A network 120 may include both wired and wireless connections, including optical links. The system 100 also includes a data source 125, which may be a server or other computer configured to transmit data (video, audio, or other data) to the communications device 105 via the network 120.

It is worth noting that aspects of the present invention may be applied to a variety of devices (such as communications device 105) generally and, more specifically, may be applied to mobile digital television (MDTV) devices. Aspects of the present invention may be applied to digital video broadcast standards that are either in effect or are at various stages of development. These may include the European standard DVB-H, the Japanese standard ISDB-T, the Korean standards digital audio broadcasting (DAB)-based Terrestrial-DMB and Satellite-DMB, the Chinese standards DTV-M, Terrestrial-Mobile Multimedia Broadcasting (T-MMB), Satellite and terrestrial interaction multimedia (STiMi), and the MediaFLO format proposed by Qualcomm Inc. While the present invention is described in the context of the DMB standard, it may also be implemented in any of the above or future standards, and as such is not limited to any one particular standard.

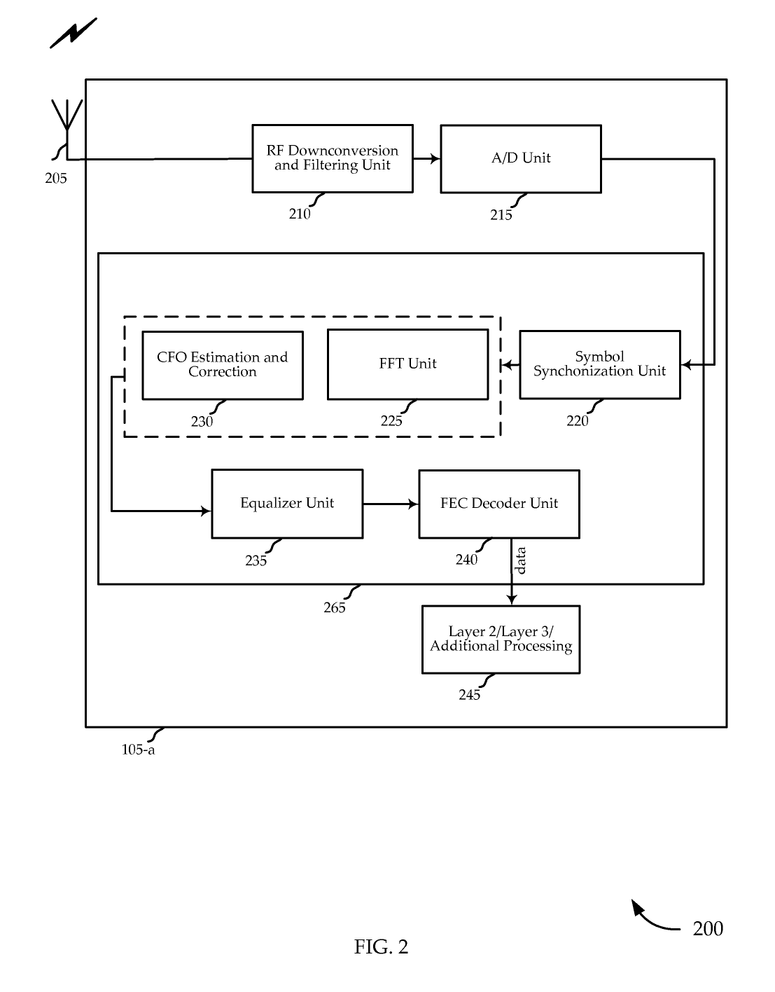

In one embodiment, the system 100 is an OFDM system. At the base station 110 of such a system, the QAM symbols are modulated by means of an IFFT (inverse fast fourier transform) on N parallel subcarriers. Referring to FIG. 2, an example block diagram 200 of a communications device 105-a is shown which illustrates various embodiments of the invention. The illustrated device 105-a may be the communications device 105 described with reference to FIG. 1. In the following embodiments, assume an orthogonal frequency division multiplexing (OFDM) system is implemented, while realizing that the principles described are applicable to a range of both wireless and wireline systems.

The device 105-a includes a number of receiver components, which may include: an RF down-conversion and filtering unit 210, A/D unit 215, symbol synchronization unit 220, FFT unit 225, carrier frequency offset estimation and correction unit 230, equalizer unit 235, and FEC decoder unit 240. These units of the device may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

In one embodiment, the radio frequency signal is received via an antenna 205. The desired signal is selected and down-converted and filtered through the RF down-conversion and filtering unit 210. The output of that unit 210 is the analog baseband (or passband at much lower frequency than the original radio frequency) signal, which is converted into digital signal by the A/D unit 215. At the symbol synchronization unit 220, the signal is grouped into symbols with symbol boundary properly identified, and the guard periods (typically cyclic prefix) are removed. Embodiments of the invention may be implemented in the symbol synchronization unit 220. The signal is provided to FFT unit 225, where it is transformed to the frequency domain. At the carrier frequency offset estimation and correction unit 230, the frequency offset of the signal is corrected. In different embodiments, the carrier frequency offset and symbol timing errors may be estimated and corrected before and/or after the FFT is performed.

The signal is then processed by the equalizer unit 235. With orthogonality, the subcarriers do not interfere with each other, so a frequency-domain equalizer can be implemented separately for each subcarrier (sometimes also called bin or carrier). Since the symbols are separated by some guard time period (cyclic prefix), the inter-symbol-interference (ISI) may be avoided.

The equalized signal may be forwarded to a FEC decoder unit 240, which may decode the signal and output a stream of data. This data stream may be forwarded to a layer 2/layer 3/additional processing unit 245 for further processing. It is worth noting that in one embodiment, the symbol synchronization unit 220, FFT unit 225, carrier frequency offset estimation and correction unit 230, equalizer unit 235, and FEC decoder unit 240 are receiver components implemented in a single PHY chip 265. It is also worth noting that, in another embodiment, the RF down-conversion and filtering unit 210, A/D unit 215, symbol synchronization unit 220, FFT unit 225, carrier frequency offset estimation and correction unit 230, equalizer unit 235, and FEC decoder unit 240 are implemented in a single chip with RF and PHY functionality.

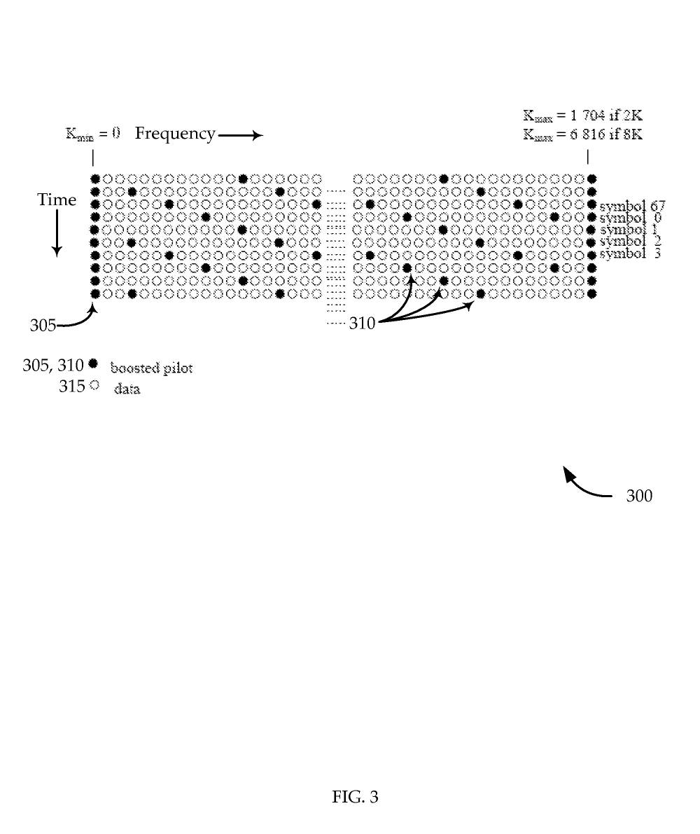

Turning to consider in greater detail certain functions that may be performed by symbol synchronization unit 220, it is worthwhile to make a closer examination of the OFDM signal model. An OFDM symbol is generally made up of subcarriers (complex sinusoids), whose number N is determined by the FFT size. For DVB-H, subcarriers are divided into three groups. One group is made up of data subcarriers, which are utilized for data transmission. A second group is made up of pilot subcarriers, which carry known information to both the transmitter and receiver (e.g., the base station 110 and device 105) to be used for various estimation purposes. Finally, null subcarriers are non-active tones used for guard bands (but are not discussed further herein). By way of example, FIG. 3 illustrates an example index 300 for DVB-H. The pilots are of two different types: continuous pilots 305 (CP) which occupy fixed carrier locations and scattered pilots 310 (SP) which change location from one OFDM symbol to the next. The data subcarriers 315 are also illustrated. The scattered and continuous pilots are also found in ISDB, for instance, among other standards and protocols.

For purposes of discussion, DVB-H may be used to explain aspects of the invention, while it should be noted that principles addressed may be applied to a number of standards using a variety of multicarrier systems. The time domain (TD) description of an OFDM symbol can generally be expressed as:

$$x [ n ] = \frac{1}{\sqrt{N}} {\sum }_{k = 0}^{N - 1} X [ k ] {e}^{j \frac{2 π}{N} nk} , n = 0 , 1 , ... , N - 1 , \qquad Eq . 1$$

where X[k] is the complex modulating the kth subcarrier, and N represents the number of subcarriers. For purpose of discussion, the OFDM subcarriers can be split into two groups: one group that is made of the Scattered Pilots (SP) and indexed by the set Ω and a second group that contains the remaining carriers. Hence, the TD OFDM signal may be considered the superposition of two signals: p[n], which is the TD signal component due to the SP, and s[n], which is the signal for the remainder of the OFDM carriers, as illustrated in the following equation:

$$x [ n ] = \underbrace{\frac{1}{\sqrt{N}} {\sum }_{k ∈ Ω} X [ k ] {e}^{j \frac{2 π}{N} nk}}_{p [ n ]} + {\underbrace{\frac{1}{\sqrt{N}} {\sum }_{k ∉ Ω} X [ k ] {e}^{j \frac{2 π}{N} nk}}}_{s [ n ]} , n = 1 , 1 , ... , N - 1. \qquad Eq . 2$$

In one embodiment, a transmitted OFDM symbol (e.g., a transmission from base station 110 to communications device 105) propagates through the (wireless) multi-path communication channel. The channel may be modeled as a tapped delay line expressed as:

$$h [ n ] = {\sum }_{l = 0}^{L - 1} {h}_{l} δ [ n - l ] , \qquad Eq . 3$$

where L is the channel length, and {hₗ} are the complex path gains. Assuming additive uncorrelated complex noise, the received baseband signal corresponding to the useful OFDM symbol may be expressed as:

$$\begin{matrix}r [ n ] = h [ n ] * x [ n ] \\ = {\sum }_{l = 0}^{L - 1} {h}_{l} x [ n - l ] + w [ n ] \\ = {\sum }_{l = 0}^{L - 1} {h}_{l} p [ n - l ] + \underbrace{{\sum }_{l = 0}^{l - 1} {h}_{l} s [ n - l ] + w [ n ]}_{I [ n ]} .\end{matrix} \qquad Eq . 4$$

In the frequency domain (FD), the SP sequence occupies periodic OFDM carrier locations. For example, in DVB and ISDB, every 12th carrier is an SP tone. The starting point of the SP tones changes regularly from one symbol to the next, hence creating four different SP phases. Therefore, the SP sequence may be represented in the FD by the following equation:

$$X [ k ] = \{ \begin{matrix}X [ q ] = PRBS [ k ] , k = M + 12 q + 3 φ \\ 0 , otherwise\end{matrix} \qquad Eq . 5$$

where φε{0,1,2,3} is the SP phase and M is the OFDM carrier offset due to the guard band. By plugging the FD SP sequence of Eq. 5 into the TD signal from Eq. 1, the following equation is obtained:

$$p [ n ] = 1 \frac{1}{\sqrt{N}} {e}^{j \frac{2 π}{N} ( M + 3 φ )} {\sum }_{q = 0}^{{N}^{′} - 1} X [ q ] {e}^{j \frac{2 π}{N} 12 nq} , \\ n = 0 , 1 , ... , N - 1 \\ where {N}^{′} = int ( \frac{N}{12} ) . \qquad Eq . 6$$

Therefore, for any positive integer T,

$$p [ n + T ] = \frac{1}{\sqrt{N}} {e}^{j \frac{2 π}{N} T ( M + 3 φ )} {e}^{j \frac{2 π}{N} n ( M + 3 φ )} {\sum }_{q = 0}^{{N}^{′} - 1} X [ q ] {e}^{j \frac{2 π}{N} 12 nq} {e}^{j \frac{2 π}{N} 12 Tq} , \\ n = 0 , 1 , ... , N - 1. \qquad Eq . 7$$

Consequently, if

$$\frac{12 T}{N }$$

is an integer,

$$p [ n + T ] = \frac{1}{\sqrt{N}} {e}^{j \frac{2 π}{N} T ( M + 3 φ )} p [ n ] , n = 0 , 1 , ... , N - 1. \qquad Eq . 8$$

Eq. 8 suggests that the TD SP signal is periodic up to phase, which is determined by the SP phase and the OFDM carrier offset. Since the FFT size N is typically chosen as a power of 2 (hence not divisible by 3), the smallest integer that makes

$$\frac{12 T}{N}$$

is typically

$$T = \frac{N}{4} .$$

Additionally, the TD SP signal values that are separated by T₁ and T₂, where T₁ and T₂ are the integers closest to the fractions

$$\frac{N}{12} and 2 \frac{N}{12} ,$$

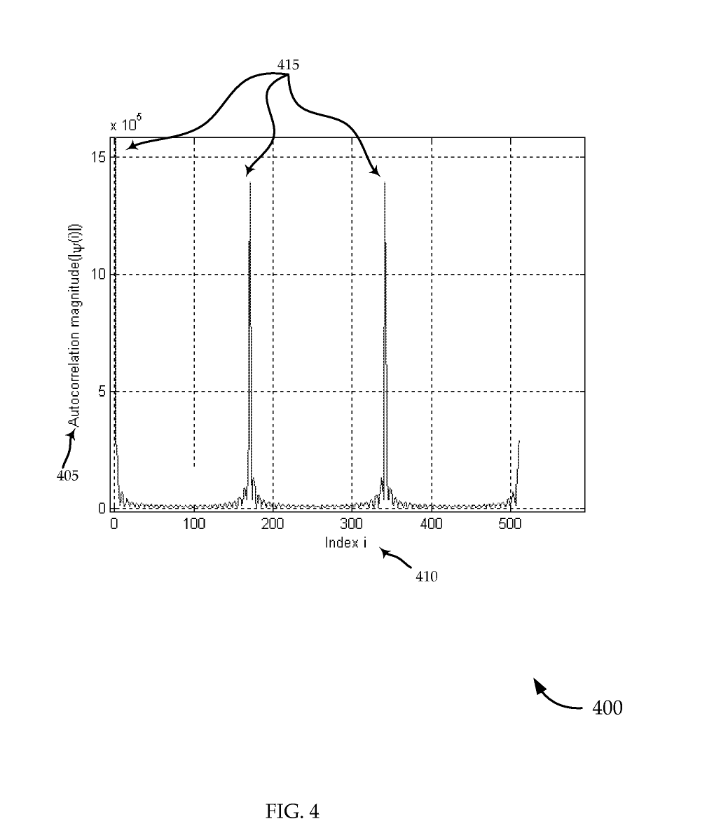

are highly correlated. Referring to FIG. 4, a graph 400 illustrates the autocorrelation magnitude 405 for one period

$$( \frac{N}{4} )$$

of the TD SP sequence Ψ(n),

$$n = 0 , … , \frac{N}{4} - 1.$$

The autocorrelation peaks 415 of graph 400 serve as an illustration of this periodicity. This periodicity of the TD SP signal may serve as a basis for tracking drift, as discussed in greater detail, below. It is worth noting that while the TD SP signals for DVB and ISDB are used for purposes of example, the periodic nature of scattered pilots in other standards or protocols, in both OFDM or other multicarrier systems, may be used in a similar fashion for tracking drift.

Having discussed the certain properties of TD SP signals related to periodicity, various methods for using these properties to track and correct drift will now be described. To discuss these steps in detail and for the ease of presentation, assume that the phase of the TD SP signal is zero (_{(M+3φ)} is a multiple of 4). Nonzero phase will be addressed below.

Assume the vector \vec{p}₀ is defined as

$${{p}^{->}}_{0} = [ \begin{matrix}p [ 0 ] \\ p [ 1 ] \\ ⋮ \\ p [ T - 1 ]\end{matrix} ] ,$$

which is formed from one period of the pilot sequence and its circular shifted version by an integer n,

$${{p}^{->}}_{n} = [ \begin{matrix}p [ n ] \\ p [ n + 1 ] \\ ⋮ \\ p [ T - 1 ] \\ p [ 0 ] \\ ⋮ \\ p [ n - 1 ]\end{matrix} ] .$$

Assume also that the corresponding receive and interference vectors are defined as:

$$\begin{matrix}{{r}^{->}}_{n} = [ \begin{matrix}r [ n ] \\ r [ n + 1 ] \\ ⋮ \\ r [ n + T - 1 ]\end{matrix} ] and & Eq . 9 \\ {{I}^{->}}_{n} = [ \begin{matrix}I [ n ] \\ I [ n + 1 ] \\ ⋮ \\ I [ n + T - 1 ]\end{matrix} ] . & Eq . 10\end{matrix}$$

Due to the periodicity of the TD SP signal, the receive data in Eq. 4 may therefore be expressed in a vector form as:

$$\begin{matrix}{{r}^{->}}_{0} = {\sum }_{l = 0}^{L - 1} {h}_{L - l - 1} {{p}^{->}}_{l} + {{I}^{->}}_{0} \\ {{r}^{->}}_{n} = {\sum }_{l = 0}^{L - 1} {h}_{L - l - 1} {{p}^{->}}_{m} + {{I}^{->}}_{n} , m = mod ( l + n , T ) .\end{matrix} \qquad Eq . 11$$

Note that while the above is described in vector form, other representations of the signal may be used. Regardless of the particular expression, a received pilot signal periodic in the TD may then be correlated with a known pilot signal. In one embodiment, the process cross-correlates the receive data vectors with TD SP \vec{p}₀. In vector form, this cross-correlation may be expressed as:

$$\begin{matrix}{u}^{->} = [ \begin{matrix}{{r}^{->}}_{0}^{H} \\ {{r}^{->}}_{1}^{H} \\ ⋮ \\ {{r}^{->}}_{T - 1}^{H}\end{matrix} ] {{p}^{->}}_{0} \\ = [ \begin{matrix}{{p}^{->}}_{0}^{H} {{p}^{->}}_{0} & {{p}^{->}}_{1}^{H} {{p}^{->}}_{0} & … & {{p}^{->}}_{L - 1}^{H} {{p}^{->}}_{0} \\ {{p}^{->}}_{1}^{H} {{p}^{->}}_{0} & {{p}^{->}}_{2}^{H} {{p}^{->}}_{0} & … & {{p}^{->}}_{L}^{H} {{p}^{->}}_{0} \\ ⋮ & ⋮ & ⋮ & ⋮ \\ {{p}^{->}}_{T - 1}^{H} {{p}^{->}}_{0} & {{p}^{->}}_{0}^{H} {{p}^{->}}_{0} & … & {{p}^{->}}_{L - 2}^{H} {{p}^{->}}_{0}\end{matrix} ] \overline{[ \begin{matrix}h [ L - 1 ] \\ h [ L - 2 ] \\ ⋮ \\ h [ 0 ]\end{matrix} ]} + \\ interference = \\ = {\sum }_{l = 0}^{L - 1} \overline{{h}_{l}} {{Ψ}^{->}}_{l} + interference\end{matrix} \qquad Eq . 12$$

where the vector

$${{Ψ}^{->}}_{0} = [ \begin{matrix}Ψ [ 0 ] \\ Ψ [ 1 ] \\ ⋮ \\ Ψ [ T - 1 ]\end{matrix} ]$$

may hold the autocorrelation sequence of \vec{p}₀, and \vec{Ψ}ₗ is its circular shifted version by l. The resulting cross-correlation sequence \vec{u} is a weighted sum (by the channel gains) of different circularly shifted versions of the signal depicted in FIG. 3. Thus, in one embodiment, \vec{u} will serve as a reference sequence against which a potential drift will be assessed. In other embodiments, other correlations between a periodic pilot signal and a received signal may serve as the reference to assess drift. In still other embodiments, a correlation between another form of reference signal known at the receiver (e.g., a non-periodic pilot sequence) and a received signal may serve as the reference to assess drift.

In one embodiment, after the reference correlation is calculated (e.g., at the start of a monitoring period), a new cross-correlation \vec{v} between the incoming receive data and \vec{p}₀ is computed similar to Eq. 12. If there is no significant drift occurring since the computation of \vec{u}, Eq. 11 holds except perhaps for 1) a possible change in the value of the interference vectors \vec{I}ₙ (which may be due to the changes in OFDM data and noise), and 2) a possible change in values of the channel gains (due to changes in channel condition). If, on the other hand, a left or right drift has taken place (e.g., Δ samples are missed or inserted), the TD SP sequence in Eq. 11 is delayed by Δ samples. The circular shift indices for \vec{p}ₙ may be augmented by the signed value Δ. Therefore, \vec{v} may be expressed as:

$${v}^{->} = {\sum }_{l = 0}^{L - 1} \overline{{h}_{l}^{′}} {{Ψ}^{->}}_{l + Δ} + interference . \qquad Eq . 13$$

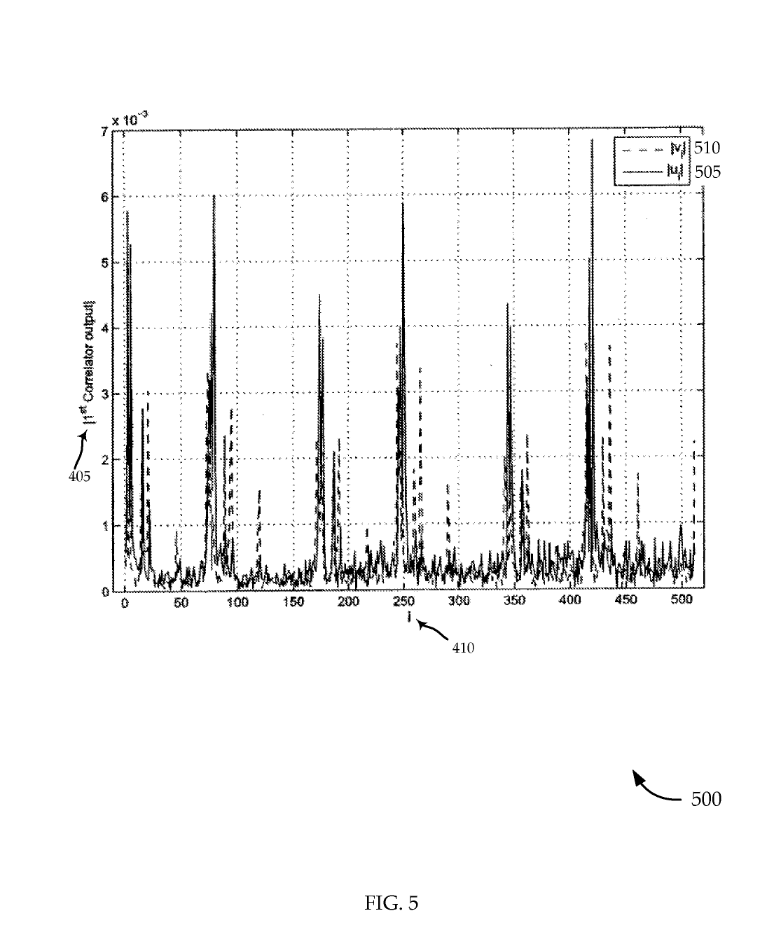

FIG. 5 is a graph 500 representing a comparison of a reference correlation 505 and monitoring correlation 510 for an embodiment of the invention. Note how the monitoring correlation 510 resembles a delayed version of the reference correlation 505. This relationship may be processed in a variety of ways to estimate the drift.

As noted above, \vec{u} is but one example of a reference correlation between a known control signal (e.g., a periodic pilot signal) and a received signal. Therefore, in some embodiments, other correlations may be used instead of v for the monitoring correlation (i.e., the correlation between a later received signal and the control signal). The interval in time between the reference correlation and the monitoring correlation may be configured to be dynamically variable. Thus, intervals may be extended when there has been a period of little or no drift, and shortened in periods when the severity or rate of drift is high or drift has otherwise been unstable.

A difference measurement is then made between the reference correlation and the monitoring correlation. By performing a difference measurement between the reference correlation and the monitoring correlation (or, more specifically, a difference measurement between \vec{u} and \vec{v}), the drift may be estimated. A variety of difference measures between the between the reference correlation and the monitoring correlation may be used.

Returning to the example embodiment relating to \vec{u} and \vec{v}, due to a potential mismatch of channel vectors corresponding to \vec{u} and \vec{v}, the dot product may add up constructively or destructively, leading to an incorrect Δ. In one embodiment, to estimate the drift value Δ and its sign, the absolute value of the \vec{v} is cross-correlated with a bank of absolute values of a delayed version of \vec{u}, and then the absolute value of \vec{u} is cross-correlated with a bank of absolute values of a delayed version of \vec{v}, as illustrated with Eq. 14:

zₚ(i)=|\vec{u}ᵢ|^{T}|\vec{v}|, i=0,1, . . . , Dₘₐₓ

zₙ(i)=|\vec{v}ᵢ|^{T}|\vec{u}ᵢ| Eq. 14

where Dₘₐₓ is a maximum anticipated delay. This parameter allows for system adaptability to different delay cases and reduction of computational costs when not needed. For example, Dₘₐₓ may be reduced when the drift is small and/or stable, and increased as the severity or variance of the drift increases.

As noted, the drift may then be calculated based on the difference measurement(s). The difference measurement may consist of one or more cross-correlations (e.g., zₙ(i) and zₚ(i)) between the reference correlation and the monitoring correlation, and the cross-correlations may be used to produce a delay profile which reflects the drift. In one embodiment, to finally obtain the drift, the following decision equations may be used:

$$\begin{matrix}\vert Δ \vert = \{ \begin{matrix}0 , if \vert {max}_{i} ( {z}_{p} ( i ) ) - {max}_{i} ( {z}_{n} ( i ) \vert > {V}_{min} \\ {arg}_{i} ( max ( {z}_{p} ( i ) ) , max ( {z}_{n} ( i ) ) , otherwise ,\end{matrix} \\ sign ( Δ ) = \{ \begin{matrix}1 , {max}_{i} ( {z}_{p} ( i ) ) > {max}_{i} ( {z}_{n} ( i ) ) \\ - 1 , otherwise\end{matrix}\end{matrix} \qquad Eq . 15$$

The drift may develop incrementally by a fraction of a sample. To detect and correct a drift, the threshold Vₘᵢₙ may be set as a parameter on the relative peaks. Depending on the difference between zₙ(i) and zₚ(i), Vₘᵢₙ is a setting that provides control related confidence level of the drift. Vₘᵢₙ may be a term that is set to vary dynamically based on any number of different factors. When the drift is above the threshold, the correction may be made, and \vec{v} (or the other monitoring correlation) may become the reference.

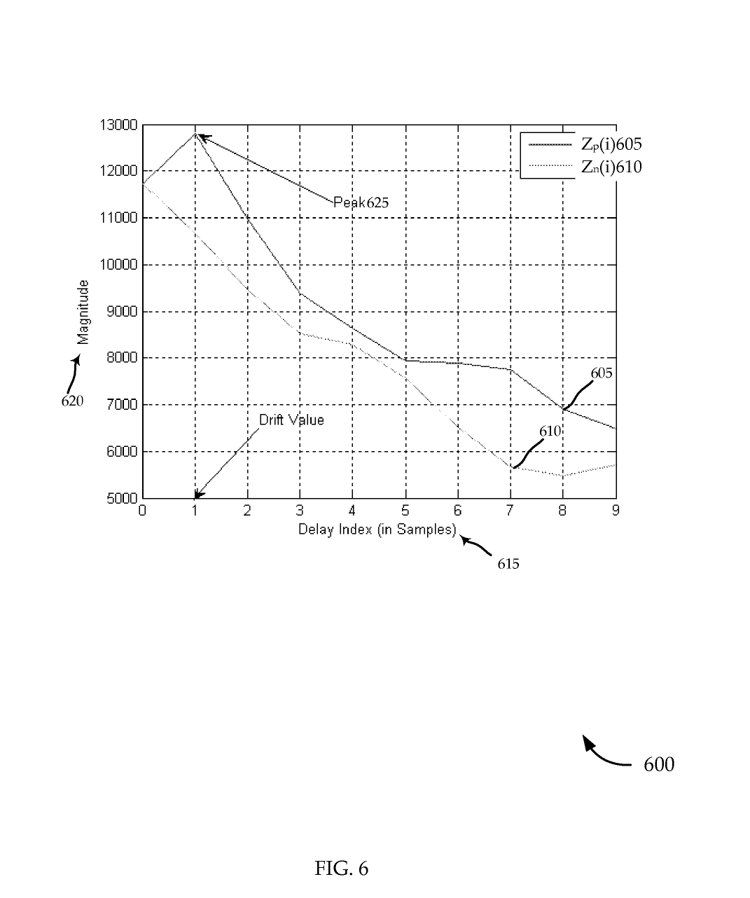

FIG. 6 is a graph 600 illustrating an example delay profile. The correlation magnitude 620 at different drift estimations 615 (in samples), for both positive zₚ(i) 605 and negative zₙ(i) 610 delays, is shown. Note peak delay 625 reflects a positive drift corresponding to one sample. Also note the difference between the relative peaks of zₚ(i) 605 and zₙ(i) 610 at the first sample—if this difference exceeds Vₘᵢₙ, the estimated delay will be a positive one sample delay in one embodiment. As noted, a variety of other difference measurements may be used to estimate the delay, and this graph 600 only illustrates example embodiments.

A number of other variations are possible. For example, according to Eq. 11, only a quarter of the receive signal samples are utilized (T samples). However, because of the periodicity of the TD SP signal embedded in the receive samples, the entire number of receive samples may be used. This may enhance the accuracy of the drift estimate. The increase in computational complexity may be reduced by “wrapping” the receive signal in four before calculating the cross-correlation sequence. In other words, the samples that are T positions apart and a vector of T samples may be added. Because certain TD SP signals for Eq. 8,

$${e}^{j \frac{2 π}{4} ( M + 3 φ )} \neq 1 ,$$

these phases will be accounted for when wrapping the receive signals. This may be done by multiplying the samples with the conjugate of the phase corresponding to that particular period. For example, if

$${e}^{j \frac{2 π}{4} ( M + 3 φ )} = j ,$$

where j=\sqrt{−1}, the our T samples of the receive signal may be multiplied by 1, (−j), (−j)², (−j)³ respectively. Note here that

$${e}^{j \frac{2 π}{4} ( M + 3 φ )} ∈ \{ 1 , - 1 , j , - j \} ;$$

the multiplications mentioned are implemented by just changing the signs of the real and/or the imaginary part of the receive samples.

It is also worth noting that the TD SP signal may have four phases (e.g., in DVB and ISDB). The signals may be uncorrelated among themselves because of their exclusive frequency contents. This may be exploited to further enhance the tracking algorithm. For example, one way to do so is to combine zₚ and zₙ sequences in a diversity scheme that calculates the drift with a better accuracy and confidence. Note also, in a circumstance in which a monitoring interval is less than four OFDM symbol times, the collaborative drift estimation with the four signals can be achieved.

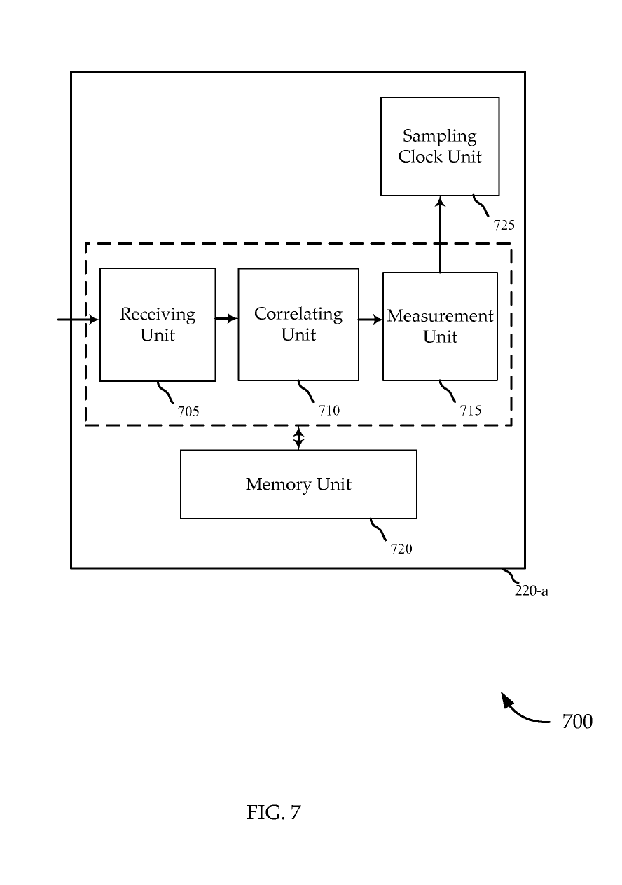

Turning to FIG. 7, a block diagram is shown illustrating an example configuration 700 of a symbol synchronization unit 220-a for sampling clock tracking and timing correction according to various embodiments of the invention. This unit 220-a of FIG. 7 may be the symbol synchronization unit 220 of FIG. 2, implemented in the communications device 105 of FIG. 1. However, some or all of the functionality of this unit 220-a may be implemented in other devices.

The symbol synchronization unit 220-a in the illustrated embodiment includes a receiving unit 705, a correlating unit 710, a measurement unit 715, a memory unit 720, and a sampling clock unit 725. These units of the device may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiving unit 705 may receive a number of wireless signals, at least some of which include a control signal known at the receiver (e.g., stored in the memory unit 720). In one embodiment, the control signal is a periodic signal. The control signal may be a set of scattered pilot tones. The received signals may, therefore, be OFDM signals sent according to the DVB standard. The received signals may, for example, be the digitized representation of such wireless signals, output from the A/D unit 215 of FIG. 2. The received signals may then be stored in memory unit 720.

The correlating unit 710 may retrieve one of the received wireless signals and the control signal from the memory unit 720, and correlate the received wireless signals and the control signal to produce a reference correlation. This reference correlation may be \vec{u} from Eq. 12, although a number of other reference correlations may be used as described above. This reference correlation may be based, at least in part, on the periodicity of the control signal (e.g., the periodicity of the scattered pilots). This reference correlation may then be stored in memory unit 720.

The correlating unit 710 may retrieve a later arriving one of the received wireless signals and the control signal from the memory unit 720, and correlate the received wireless signals and the control signal to produce a second correlation. This second correlation may be \vec{v} from Eq. 13, although a number of other forms of correlation may be used as described above. This second correlation may also be based, at least in part, on the periodicity of the control signal (e.g., the periodicity of the scattered pilots). This second correlation may also be stored in memory unit 720.

The measurement unit 715 may retrieve the reference correlation and second correlation. The measurement unit 715 may calculate a difference measurement between the reference correlation and the second correlation to estimate drift attributed to the second received signal. In one embodiment, this difference measurement is the cross-correlation of a representation of the reference correlation with a representation of the second correlation in estimating the drift.

In another embodiment, the measurement unit 715 calculates the difference measurement by generating both a positive and negative delay profile between the reference correlation and the second correlation (thus, the delay profiles may together make up the difference measurement). The measurement unit 715 may then compare the positive delay profile and the negative delay profile to estimate the drift and to identify a direction thereof (e.g., see Eq. 15, FIG. 6, and the discussion related thereto). In yet another embodiment, a minimum variance threshold is determined for the comparison of the positive delay profile and the negative delay profile. This threshold may be varied to provide control related to confidence level of the drift. The minimum variance threshold may be set so that the measurement unit 715 will send a control signal to correct the timing related to the delay only when the threshold is met or exceeded.

In performing the difference measurements, the measurement unit 715 may set and adaptively modify the window size (i.e., the number of samples searched). This window size may be the Dₘₐₓ of Eq. 14, and may be adaptively changed based on the size of the estimated drift or the variability of the estimated drift. For example, the size may be reduced when the estimated drift is small and/or stable, and increased as the severity or variance of the drift increases. The SNR may also be used to set or adaptively modify the size of the window. In some embodiments, certain thresholds may be set for drift size, variability, and/or SNR, and the window size may be based on such thresholds.

As noted, once the delay is estimated, the measurement unit 715 may transmit a correction signal to sampling clock unit 725 to control the sampling rate and thereby correct the estimated drift. The measurement unit 715 may also be configured to send other signals to correct for effects of the drift to other signal processing units.

The correlating unit 710 may be configured with additional functionality, as well. The correlating unit 710 may set and adaptively modify the time interval between the correlations to be used for the difference measurements. This may be adaptively changed based on the size of the estimated drift or the variability of the estimated drift. For example, the time intervals may be increased when the estimated drift is small and/or stable, and shortened as the severity or variance of the drift increases. The SNR may also be used to set or adaptively modify the size of the window. In some embodiments, certain thresholds may be set for drift size, variability, and/or SNR, and the time intervals may be set or modified based on such thresholds.

It is also worth noting that the symbol synchronization unit 220-a may operate in a multi-mode format. For example, the receiving unit 705 may be configured to receive and identify signals sent according to different standards. Based on this identification, the correlating unit 710 may be configured to operate in a first mode with a first control signal applicable to a first standard (e.g., DVB), of the plurality of standards, and may be configured to operate in a second mode with a second control signal applicable to a second standard (e.g., DMB). The symbol synchronization unit 220-a may operate to switch between modes based on the identification by the receiving unit 705, or perhaps by the receipt of other control information.

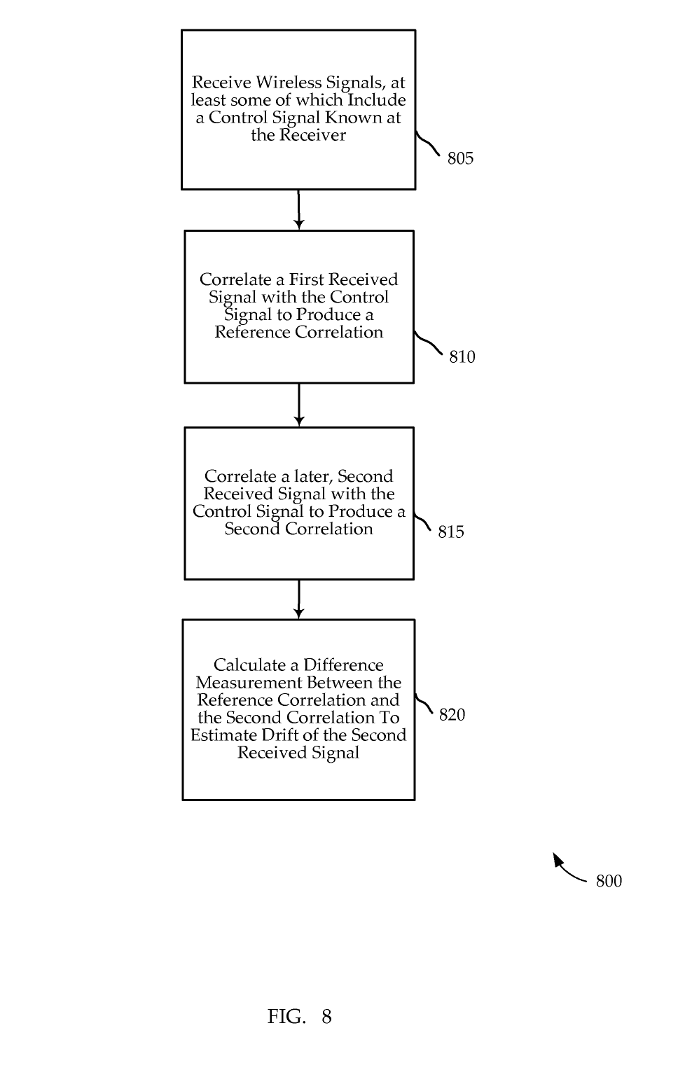

FIG. 8 is a flowchart illustrating a method 800 of sampling clock tracking according to various embodiments of the invention. The method 800 may, for example, be performed in whole or in part on the mobile communications device 105 of FIG. 1 or, more specifically, the symbol synchronization unit 220 of FIG. 2 or 7.

At block 805, wireless signals are received, at least some of which include a control signal known at the receiver. At block 810, a first received signal is correlated with the control signal to produce a reference correlation. At block 815, a later received, second wireless signal is correlated with the control signal to produce a second correlation. At block 820, a difference measurement between the reference correlation and the second correlation is calculated to estimate drift of the second received signal.

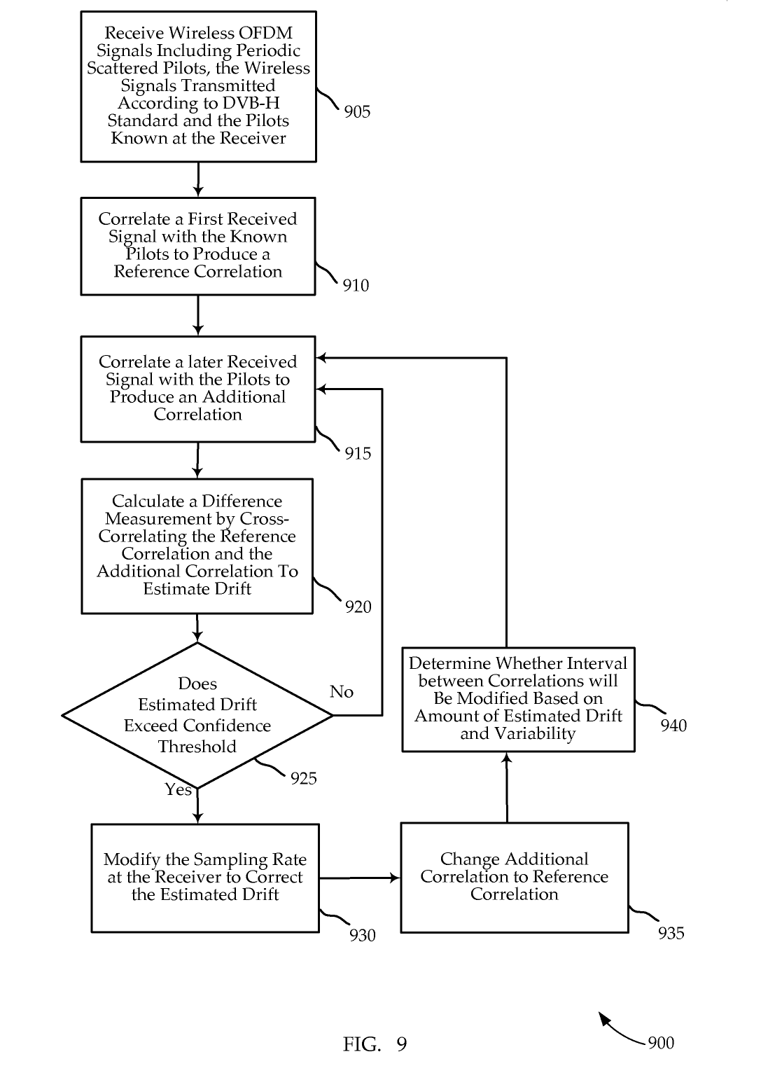

FIG. 9 is a flowchart illustrating a method 900 of sampling clock tracking and timing correction according to various embodiments of the invention. The method 900 may, for example, be performed in whole or in part on the mobile communications device 105 of FIG. 1 or, more specifically, the symbol synchronization unit 220 of FIG. 2 or 7.

At block 905, wireless OFDM signals are received, including periodic scattered pilots, the wireless signals transmitted according to DVB-H standard, and the pilots known at the receiver. At block 910, a first received signal is correlated with the known pilots to produce a reference correlation. At block 915, a later received signal is correlated with the pilots to produce an additional correlation. At block 920, a difference measurement is calculated by cross-correlating the reference correlation and the additional correlation to estimate drift.

At block 925, a determination is made whether the estimated drift exceeds confidence threshold. If the estimated drift exceeds the confidence threshold, at block 930 the sampling rate is modified at the receiver to correct the estimated drift. At block 935, the additional correlation is changed to reference correlation. At block 940, a determination is made whether the interval between correlations will be modified, the determination based on the amount of estimated drift and a variability measure of previously estimated drift. At the appropriate interval, a later received signal is correlated with the pilots to produce an additional correlation at block 915, and the re-timing loop resumes.

Alternatively, if at block 925 a determination is made that the estimated drift fails to meet the confidence threshold, the process may return to block 915, where a later arriving wireless signal is correlated with the pilots to produce a second additional correlation. At block 920, a difference measurement is calculated by cross-correlating the reference correlation and the second additional correlation to estimate drift, and the loop continues as discussed above from block 920.

Note that in still other embodiments, if a determination is made at block 925 that the estimated drift fails to meet the confidence threshold, steps other than those listed above are possible. For example, the method could return to steps 910 and 915 so that two new correlations will be performed on later arriving signals. Alternatively, the second additional correlation for a later arriving signal may be integrated with the initial additional correlation before cross-correlation with the reference correlation. Those skilled in the art will recognize other variations, as well.

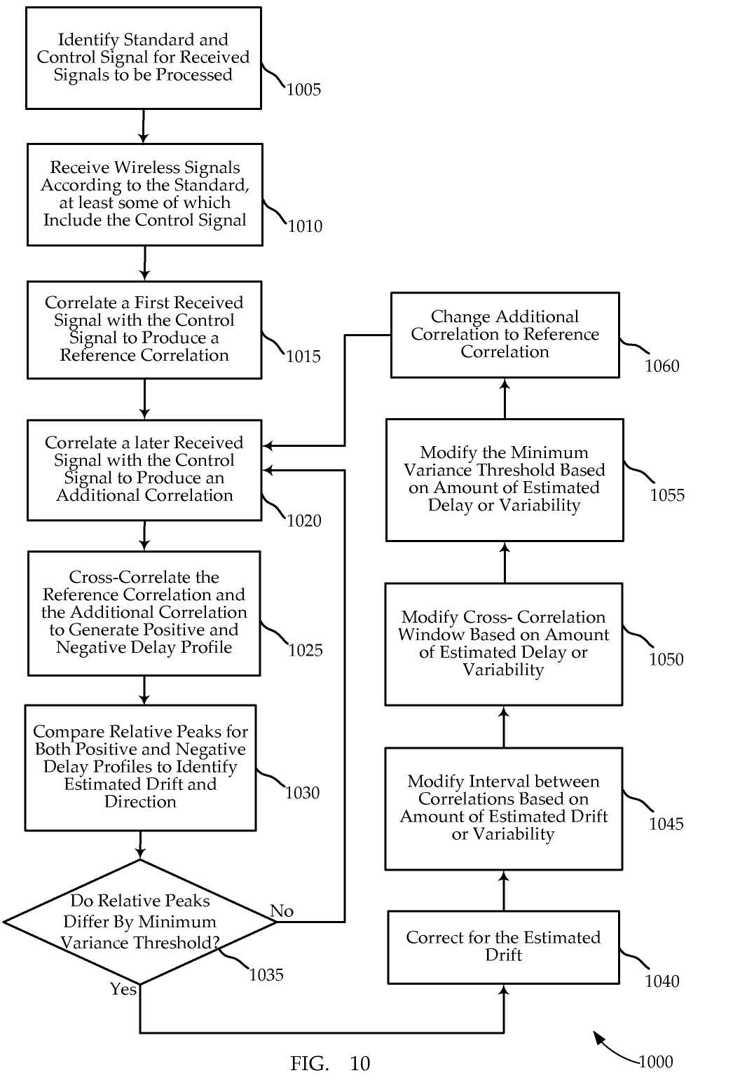

FIG. 10 is a flowchart illustrating an alternative method 1000 of sampling clock tracking and timing correction according to various embodiments of the invention. The method 1000 may, for example, be performed in whole or in part on the mobile communications device 105 of FIG. 1 or, more specifically, the symbol synchronization unit 220 of FIG. 2 or 7.

At block 1005, a video broadcasting standard and a control signal are identified for received signals to be processed. At block 1010, wireless signals transmitted according to the standard are received, at least some of which include the control signal. At block 1015, a first of the received signal is correlated with the control signal to produce a reference correlation. At block 1020, a later received signal is correlated with the control signal to produce an additional correlation.

At block 1025, the reference correlation and the additional correlation are cross-correlated to generate positive and negative delay profiles. At block 1030, relative peaks are compared for both positive and negative delay profiles to identify estimated drift and direction. At block 1035, a determination is made whether relative peaks differ by a minimum variance threshold.

If the relative peaks differ by a minimum variance threshold, at block 1040, a correction is made for the estimated drift. At block 1045, the interval between correlations is modified based on the amount of estimated drift or variability of the drift. At block 1050, the cross-correlation window is modified based on the amount of estimated drift or variability of the drift. At block 1055, the minimum variance threshold is modified based on the amount of estimated drift or variability of the drift. At block 1060, the additional correlation is changed to reference correlation and a later received signal is correlated with the control signal to produce an additional correlation. At the appropriate interval, a later received signal is correlated with the pilots to produce an additional correlation at block 1020, and the re-timing loop resumes.

Alternatively, if at block 1035 a determination is made that the estimated drift fails to meet the confidence threshold, the process may return to block 1020, where a later arriving wireless signal is correlated with the pilots to produce a second additional correlation. The process then proceeds from block 1025 with a cross-correlation between the reference correlation and the second additional correlation.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A method for sampling clock tracking at a receiver, the method comprising:
receiving a plurality of wireless signals, wherein at least a subset of the plurality of wireless signals includes a control signal known at the receiver;
correlating a first received signal of the plurality of wireless signals with the control signal to produce a reference correlation;
correlating a later, second received signal of the plurality of wireless signals with the control signal to produce a second correlation; and
calculating a difference measurement between the reference correlation and the second correlation to estimate drift for the second received signal.

2. The method of claim 1, wherein,
the control signal comprises a periodic signal; and
the correlation of the first received signal and the correlation of the second received signal are each based at least in part on periodicity of the control signal.

3. The method of claim 1, wherein,
the control signal comprises a set of scattered pilot tones;
the wireless signals are orthogonal frequency-division multiplexing (OFDM) signals; and
the device comprises a mobile communications device.

4. The method of claim 1, wherein the calculation of the difference measurement comprises:
cross-correlating a representation of the reference correlation with a representation of the second correlation in estimating the drift.

5. The method of claim 4, further comprising:
adjusting a size of a cross-correlation window based at least in part on the size of the estimated drift or a variability of the estimated drift.

6. The method of claim 1, wherein calculating the difference measurement comprises:
generating a positive delay profile between the reference correlation and the second correlation;
generating a negative delay profile between the reference correlation and the second correlation; and
comparing the positive delay profile and the negative delay profile to estimate the drift and to identify a direction thereof, wherein the positive delay profile and the negative delay profile comprise the difference measurement.

7. The method of claim 6, further comprising:
determining a minimum variance threshold for the comparison of the positive delay profile and the negative delay profile; and
controlling a sampling rate to correct the estimated drift if the comparison exceeds the minimum variance threshold.

8. The method of claim 1, further comprising:
correcting the estimated drift; and
changing a designation of the second correlation to the reference correlation based at least in part on the correction.

9. The method of claim 1, further comprising:
adaptively modifying a time interval between the second correlation and a third correlation for a third signal arriving after the second signal, the modification based at least in part on the estimated drift.

10. The method of claim 1, further comprising,
determining that the estimated drift is below a threshold; and
transmitting a control signal to extend a time interval between the second correlation and a third correlation based on the determination.

11. The method of claim 1, further comprising,
operating in a first mode wherein the control signal comprises a first control signal for a first standard of the plurality of standards; and
operating in a second mode wherein the control signal comprises a second control signal for a second standard of the plurality of standards.

12. A processor for sampling clock tracking at a receiver, the processor configured to:
correlate a first received signal including a known periodic control signal with the known periodic control signal to produce a reference correlation;
correlate a later, second received signal including the known periodic control signal with the known control signal to produce a second correlation; and
calculate a difference measurement between the reference correlation and the second correlation to estimate drift of the second received signal.

13. The processor of claim 12, wherein the processor is further configured to:
transmit a correction signal to modify a sampling rate and thereby correct the drift.

14. A device for sampling clock tracking, the device comprising:
a receiving unit configured to receive a plurality of wireless signals, wherein at least a subset of the plurality of wireless signals includes a control signal known at the device;
a correlating unit, communicatively coupled with the receiving unit, and configured to:
correlate a first received signal of the plurality of wireless signals with the control signal to produce a reference correlation; and
correlate a later, second received signal of the plurality of wireless signals with the control signal to produce a second correlation; and
a measurement unit, communicatively coupled with the correlating unit, configured to calculate a difference measurement between the reference correlation and the second correlation to estimate drift of the second received signal.

15. The device of claim 14, wherein,
the control signal comprises a periodic signal; and
the correlating unit is further configured to perform the correlations of the first received signal and the second received signal based at least in part on periodicity of the control signal.

16. The device of claim 14, wherein,
the control signal comprises a set of scattered pilot tones;
the wireless signals are orthogonal frequency-division multiplexing (OFDM) signals; and
the device comprises a mobile communications device.

17. The device of claim 14, wherein to calculate the difference measurement, the measurement unit is configured to:
cross-correlate a representation of the reference correlation with a representation of the second correlation in estimating the drift.

18. The device of claim 17, wherein,
the representation of the reference correlation comprises a first set of absolute values of vectors representative of the reference correlation;
the representation of the second correlation comprises a second set of absolute values of vectors representative of the second correlation; and
the cross-correlation comprises a cross-correlation of the first set and the second set within an adjustable delay window.

19. The device of claim 14, wherein the measurement unit is further configured to:
generate a positive delay profile between the reference correlation and the second correlation;
generate a negative delay profile between the reference correlation and the second correlation; and
compare the positive delay profile and the negative delay profile to estimate the drift and to identify a direction thereof, wherein the positive delay profile and the negative delay profile comprise the difference measurement.

20. The device of claim 19, wherein the measurement unit is further configured to:
determine a minimum variance threshold for the comparison of the positive delay profile and the negative delay profile; and
transmit a correction signal to correct for the estimated drift if the comparison exceeds the minimum variance threshold.

21. The device of claim 14, wherein the measurement unit is further configured to:
transmit a correction signal to a sampling clock to control a sampling rate and thereby correct the estimated drift.

22. The device of claim 14, wherein the correlating unit is further configured to:
adaptively modify a time interval between the second correlation and a third correlation for a third signal arriving after the second signal, the modification based at least in part on the estimated drift.

23. The device of claim 22, wherein the measurement unit is further configured to:
determine the estimated drift exceeds a threshold; and
transmit a control signal to contract the time interval between the second correlation and the third correlation based on the determination.

24. The device of claim 14, wherein,
the receiving unit is further configured to receive wireless signals from a plurality of standards; and
the correlating unit is further configured to:
operate in a first mode wherein the control signal comprises a first control signal for a first standard of the plurality of standards; and
operate in a second mode wherein the control signal comprises a second control signal for a second standard of the plurality of standards.

25. A system for tracking and correcting drift at a mobile communications device, the system comprising:
a base station configured to transmit plurality of wireless signals, wherein at least a subset of the plurality of wireless signals includes a periodic control signal known at a receiving device; and
the receiving device, in wireless communication with the base station, and configured to:
receive the plurality of wireless signals;
correlate first received signal of the plurality of wireless signals with the known periodic control signal to produce a reference correlation;
correlate a later, second received signal of the plurality of wireless signals with the known, periodic control signal to produce a second correlation;
calculate a difference measurement between the reference correlation and the second correlation to estimate drift of the second received signal; and
modify a sampling rate at the receiver to correct for the estimated drift.
